(19) United States
(12) Patent Application Publication
(10) Pub. No.: US 2007/0005867 A1
(43) Pub. Date: Jan. 4, 2007

(54) Virtual peripheral device interface and protocol for use in peripheral device redirection communication

(76) Inventor: Nimrod Diamant, Kfar-Saba (IL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/174,408

(22) Filed: Jun. 30, 2005

(51) Int. Cl. G06F 13/36

(52) U.S. Cl. 710/306

(57) ABSTRACT

A virtual peripheral device interface and protocol are described that may be used in redirecting peripheral device communication to a remote networked device. In on embodiment, the invention includes a bus adapter to connect to a bus of a managed system, a set of peripheral device bus host controller registers to provide data and commands to the bus adapter, and a network adapter to communicate data and commands between the set of host controller registers and a remote networked device.

### FIELD

The present description relates to computing systems that can be operated from a remote console, and in particular to allowing the remote console to emulate a local bus device that is directly coupled to a local bus of the computing system.

### BACKGROUND

The costs of maintaining and repairing computers can be significant. One significant factor is the time required for IT (information technology) personnel to individually maintain the operability and currency of each computer. These costs can be reduced significantly by tools that permit the IT personnel to perform maintenance and repairs remotely. For example, in a situation in which a given computer must have an operating system installed, an application installed, software updated, or settings analyzed or changed, it is inconvenient for IT personnel to physically travel to the particular computer in order to perform the maintenance, repairs, or installation. Tools that permit the installation of the operating system or other software by delivering the operating system across a network would eliminate the need for the IT personnel to travel, and therefore reduce costs.

Some systems allow a USB (Universal Serial Bus) connection to be made between a local USB port and a networking processor. The networking processor captures USB traffic on the USB port, including constant polling, and responds with standard USB signals at expected USB speeds. This allows a management console on the network to emulate a USB keyboard and mouse or other device, that is coupled to the local USB port. It also requires the networking processor to consume much of the network communication resources with polling and other overhead traffic. In addition, it occupies a local USB port whether or not the management console is being used to send keyboard and mouse commands to the networking processor.

Some system software, including operating systems and some applications, do not accept keyboard and mouse commands that are communicated through a USB connection but only accept PS/2 user input devices. However, a USB port connection to a local networking processor like that mentioned above cannot be used to emulate a keyboard and mouse on a PS/2 connection. PS/2 communications require access to an SMI (System Management Interrupt) through an LPC (Low Pin Count) bus. This cannot be done using a USB port on an add-in card, such as a PCI (Peripheral Component Interconnect) card.

### BRIEF DESCRIPTION OF THE DRAWINGS

The various advantages of the embodiments of the present invention will become apparent to one skilled in the art by reading the following specification and appended claims, and by referencing the following drawings.

FIG. 1 depicts a computing system that employs a virtual USB interface, according to an embodiment of the present invention.

FIG. 2 depicts an integrated multifunction device, including a virtual USB interface according to an embodiment of the present invention.

FIG. 3 depicts an example of a process flow for USB redirection according to an embodiment of the present invention.

FIG. 4 depicts an example of a host system equipped for USB redirection according to an embodiment of the present invention.

FIG. 5 depicts an example of host system equipped for PS/2 redirection through USB controllers according to an embodiment of the present invention.

FIG. 6 depicts an example of a process flow for PS/2 redirection according to an embodiment of the present invention.

### DETAILED DESCRIPTION

As used herein the terms “USB”, “USB device”, “USB port”, “USB hub” and the like refer to standards for the Universal Serial Bus and similar standards. The specifications for USB are promulgated by the USB (Universal Serial Bus) Implementers Forum. The current primary specification includes the Universal Serial Bus Revision 2.0 Specification updated Dec. 21, 2000. This standard may be updated later and other standards under development include USB On-The-Go, and Wireless USB.

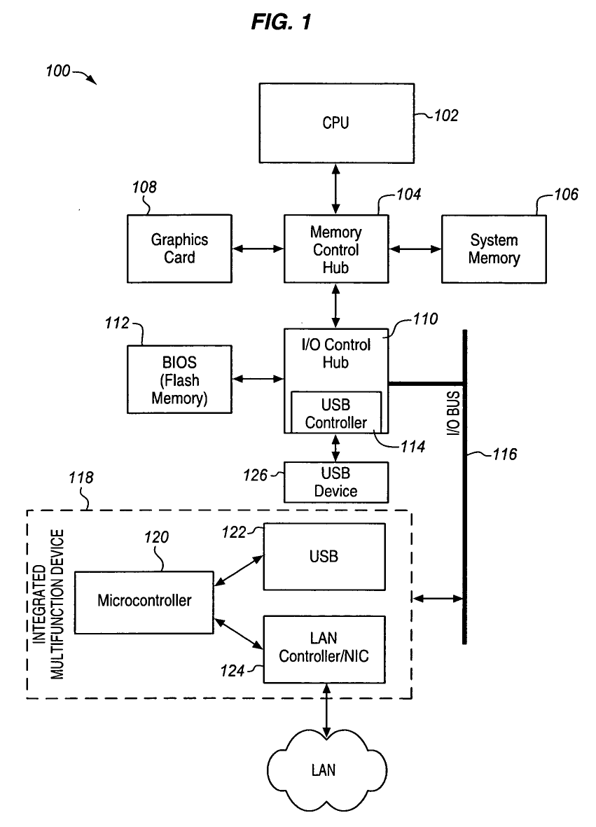

FIG. 1 depicts one example of a computing system 100 that redirects device commands and data to a network, without rooting the source of such redirection in the system BIOS. As can be seen from FIG. 1, the computing system 100 includes a CPU 102, which is coupled to a memory control hub 104. The memory control hub 104 is an arrangement of circuitry that manages and controls access to the system memory 106, graphics card 108, and the input/output (I/O) control hub 110. The I/O control hub 110, in turn, manages and controls access to a flash memory device 112, which stores the BIOS. In one embodiment, it manages and controls access to a USB controller 114, which is embodied as a part of the I/O control hub 110. A USB device 126 is coupled to the controller 114. The USB device 126 communicates data and commands to and from the host via the controller 114. In another embodiment, the I/O control hub 110 also manages and controls access to an I/O bus 1 16, such as a peripheral component interconnect (PCI) bus. (In an embodiment, the I/O control hub 110 also manages and controls access to audio channels, IDE ports, and other I/O devices that are known in the art, but are not important in the context of this disclosure, and are not depicted herein).

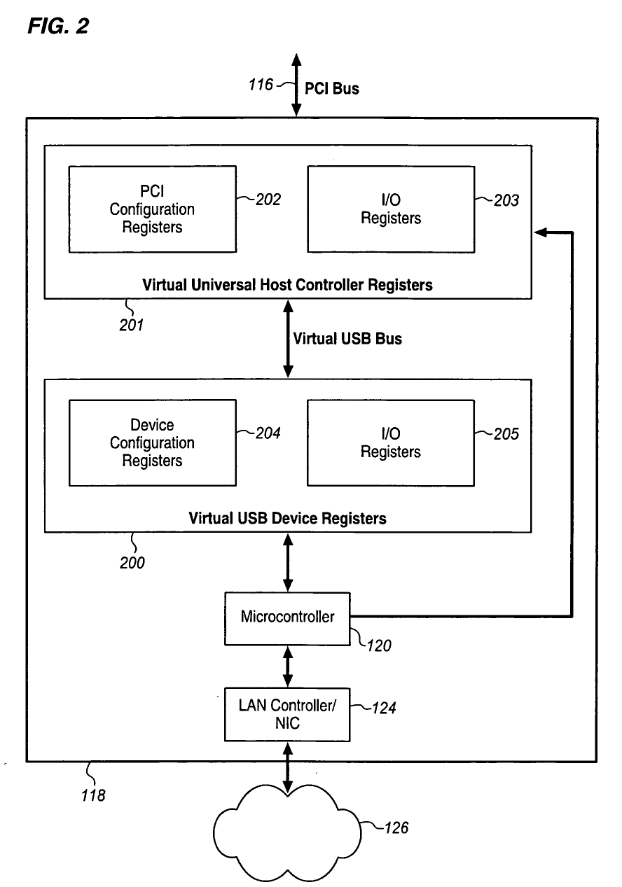

Coupled to the I/O bus 116 is an integrated multifunction device 118. As discussed in more detail below, an integrated multifunction device 118 is a single device that provides more than one function. In the particular example depicted in FIG. 2, the integrated multifunction device 118 is a single device that offers a USB device function and a LAN controller function. Such an integrated multifunction device 118 may be presented in the marketplace as a LAN controller with built-in manageability features.

The integrated multifunction device 118 may include a microcontroller 120 coupled to a virtual USB interface 122 (discussed below) and a LAN controller 224. By “virtual” USB interface it is meant that the interface presents a set of registers appearing in size, number, and behavior as belonging to a USB host controller, when in fact no host controller or USB device exists. Such a non-existent controller is said to be a “virtual USB controller.” The just-mentioned registers serve as an interface between the virtual USB functionality provided by the integrated multifunction device 118 and software running on the CPU 102. In other words, data and commands are read from and written to the USB function by reading from and writing to the registers. Further, the behavior of the USB function is controlled by writing to and reading from the registers in a manner to mimic the behavior of a USB host controller and any real or virtual devices that may be coupled to the virtual controller.

As discussed in greater detail below, the integrated multifunction device 118 is accessed in a manner identical to that of a USB host controller on a peripheral device bus. The device 118 receives commands, and forwards the commands via a network to a remote computer that interprets the commands and accesses a data set, in response to the commands. For example, the device 118 may receive a command to read a given disc sector of a USB hard disk drive. The device 118 forwards the command, via the network, to a remote computer. The remote computer accesses a data set to find the information that would have been found had the disc sector been read by a physically present device. The data is returned to the device 118 via the network. The device 118 returns the data to the host via the virtual USB host controller 122.

Notably, in one embodiment, such a computer system 100 does not have a physical drive present. In other words, there is no IDE or USB hard disk drive, as might be the case in the context of a network computer. All drive access commands are routed through the device 118 to the aforementioned remote computer. In another embodiment, though, the computer system 100 may have a physical drive, such as IDE device 126 present, as shown in FIG. 1. The USB host controller is then used to connect to additional real or virtual USB devices, such as storage devices and I/O devices.

FIG. 2 depicts the integrated multifunction device 118 in greater detail, including a set of virtual USB device registers 200 and a set of virtual USB universal host controller registers 201. As can be seen, the microcontroller 120 residing on the integrated multifunction device 218 is coupled to the set of virtual USB device registers 200. The set of virtual USB device registers include device configuration registers 204 and I/O registers 205. The uses and purposes of the above-mentioned registers are known for USB devices, and are described by the USB Implementing Forum standards mentioned above.

The set of virtual USB controller registers 201 includes the configuration space registers 202 and the I/O registers 203. As suggested by the name, the virtual USB controller registers 201 are dimensioned in size and quantity to be identical to the registers ordinarily found in a standard USB controller (like the one in identified by reference numeral 114 in FIG. 1, embodied in the I/O control hub 110).

As stated above, the microcontroller 120 executes firmware or software stored in a memory device (not depicted), which causes the microcontroller 120 to read from and write to the registers 200 and 203 as though the integrated multifunction device 118 actually was a USB controller with a USB device or USB devices coupled thereto.

Returning to FIG. 2, therein is depicted a set of virtual USB device registers 200. By this, it is meant that although the set of USB device registers 200 exists, there exists no USB device associated therewith. From the vantage of the CPU (not depicted), however, it is not apparent that no actual USB device exists. The microcontroller 120 reads from and writes to the set of virtual USB device registers 200 and bus master registers 203 in a manner mimicking that of a real USB controller with a real USB device coupled thereto. Thus, for example, when the host requests a READ SECTORS command to be executed by the virtual USB device, it does so in the same way that it would request a READ SECTORS command to be executed by a real USB device. Specifically, the host indicates the starting logical block of the sectors to be read, indicates the number of sectors to be read, and indicates which device the command is directed toward. After having loaded the appropriate values in the above-mentioned registers, the host writes the command code indicating the READ SECTORS command to a command register. In the wake of writing to the command register, hardware sets the device busy bit in a status register, and the microcontroller 120 reads the virtual set of USB device registers 200. Thereafter, the microcontroller 120 communicates the READ SECTORS command via a network controller 124 and network to a management console (discussed in further detail, below).

The management console receives the READ SECTORS command, interprets the command, prepares the data based upon image data stored at the management console, and returns the data to the microcontroller 120. When the data is received by the microcontroller 120 and is ready to be read from the data register in the virtual USB interface 200, the microcontroller 120 writes to the status register to indicate that the device is not busy, and asserts the data request bit therein. The host responds by obtaining the data from the device, by virtue of a series of reads from the data register. Again, the data is transferred to the host in blocks, and the microcontroller 120 controls the registers of the virtual interface 200, so as to cause the host to traverse the same series of state transitions it would traverse, if a real USB device were coupled to the virtual set of USB device registers 200 and were transferring the data to the host. Thus, from the vantage of the CPU 102, the virtual set of USB registers 200 and bus master registers 203 may be used in an identical manner to that of a real USB controller with a real USB device coupled thereto.

One advantage of employment of a set of virtual USB device registers and bus master registers is that the redirective capacity of the computing system employing such registers does not hinge upon the design of the BIOS or operating system. Instead, the redirective capacity of the system results from the ability of a device having access to a network to present a set of registers to the CPU that is indistinguishable from a real USB controller and device. Therefore, a redirection scheme employing a set of virtual USB device registers (such as registers 200) and bus master registers (such as registers 203) can be used to provide any functions that may be offered by any USB device.

Returning to FIG. 2 and a discussion of the structure of the integrated multifunction device 118, the integrated multifunction device 118 may also include a LAN controller 124. The LAN controller 124 includes a set of registers through which the CPU 102 interfaces with the LAN controller 124 functionality. Of course, the LAN controller 124 also includes circuitry to perform low-level functionality including interfacing with the physical communication medium. The integrated multifunction device 118 may be embodied as a single chip, or may be embodied as multiple chips that cooperate with one another.

A set of virtual USB device registers may be made available to a CPU by providing a configuration space that announces the presence of a USB interface function in a device. For example, if the integrated multifunction device 118 is a PCI compatible device, then it includes a PCI configuration space 202, which is a set of registers including a class code register and base address registers (BARs). The class code register 204 contains a value identifying the sort of function provided by the device. Thus, in the context of a device providing a virtual USB device (or an ordinary USB device), the class code register 204 contains a value identifying a USB host controller interface function. The base address registers are provided in the configuration space 202 so that the BIOS may store therein I/O addresses pointing to the set of virtual USB device registers 200 (or one or more registers therein).

During startup, the BIOS traverses each I/O bus (such as PCI bus 116) and seeks out each device. Each device found is enumerated. Furthermore, the BIOS seeks out each function offered by each device, such as the virtual universal host controller. Each function of each device is also enumerated. During this process, the BIOS stores an I/O address in each of the base address registers of the configuration space associated with each function of each device. Based on the I/O addresses stored in the base address registers, the BIOS can determine how to address a particular function on a particular device.

The management console (not depicted) is a computer system that communicates with the managed computing system 100 (FIG. 1). The term “managed computing system” refers to a system employing a USB redirection scheme, such that it receives device data from a remote system (i.e., management console). The management console runs an identical protocol stack, so that it can properly interpret the commands received from the managed computing system 100.

IT personnel at the management console may add and remove any number of different USB devices using the LAN interface to the virtual USB host controller. These devices may include a keyboard and mouse, hard disk drive, floppy disk drive or other storage devices, audio and video devices, or any other device supported by USB. The added device may be a real device or a virtual device emulating a real device through the virtual universal host controller. If the emulated device is a storage disk, such as a boot floppy drive, or a hard disk drive, then the IT personnel at the management console may instruct the managed computing system to boot-up using the virtual USB device. Then, the IT personnel may re-boot the managed system 100. The managed system 100 then accesses the virtual USB device in the same manner that it accesses an ordinary, physically present device. The USB commands from the managed system are forwarded to the management console. The management console maintains a set of image device data for the managed system 100. The management console interprets the USB commands and operates upon the image device data (i.e., reads from the image data, writes to the image data, etc.). If the emulated device is an input device, such as a keyboard or mouse, then the IT personnel may send commands and data to the managed computing system.

Using the architecture shown in FIGS. 1 and 2, the manageability-enabled platform 100, that is a host computer with an integrated multifunction device 118, may emulate a USB “hot-controller.” This may be done by exposing a standard USB host controller PCI configuration space and standard USB host controller runtime registers to the host. In one embodiment, firmware on the manageability-enabled platform senses read and write operations to the virtual USB registers by the host software, which may be the BIOS, an operating system or a driver. The firmware may traverse the host memory at the USB descriptors and buffers to derive information on the various USB tasks to be performed. These commands and tasks information is collected as it appears in the universal host controller memory and, in one embodiment, is processed by firmware.

The commands and tasks may include writing to the universal host controller memory as USB result or status data. This written data may be encapsulated by the microcontroller in a software or firmware process into payloads that are sent over the LAN connection to the management console. The data may be combined, for example, into Ethernet packets for USB redirection protocol packets.

When the USB redirection protocol packets are received at the management console, they are reassembled into register values and interpreted. The management console may link the packets to a particular USB device to emulate, generate a response and then send the response back over the LAN to the host machine. These results are in turn, received by the multifunction device and written to the universal host controller memory registers. The response at the host machine that is generated from the management console emulates the operation of real USB devices of any desired type connected to a PCI USB host controller.

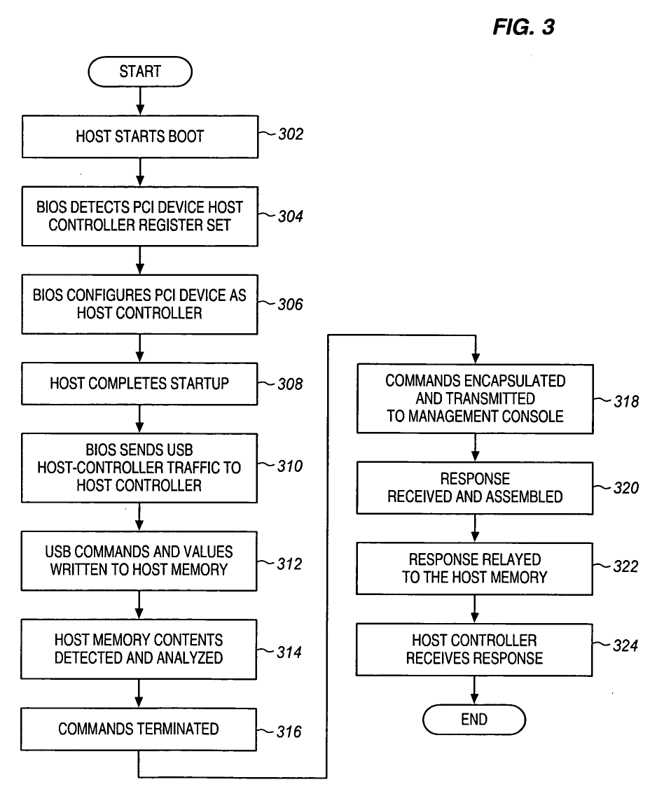

FIG. 3 shows an example of a process flow that may be performed by a host machine in accordance with one embodiment of the invention. At block 302, the host platform starts to boot or starts a reset. At block 304, the BIOS detects a device on the local PCI bus that has the standard PCI register set for a universal host controller. At block 306, the BIOS treats the set of registers as a universal host controller and starts as if a physical host controller were connected to the PCI slot. At block 308, the host machine completes the start-up or reset and the operating system and any startup applications are loaded. The host platform is operational with a PCI universal host controller registered in the BIOS. As with any real universal host controller, any virtual USB device coupled to the virtual universal host controller, will have the plug-and-play capabilities of a physical USB device. The virtual USB devices should be able to be connected and disconnected from the virtual universal host controller at any time while the system is running without disrupting any other ongoing process. This is particularly useful for remote access to a machine.

After the system has started up and is running, the host's BIOS sends USB hot-controller traffic to the host controller register set and associated host memory at block 310. At block 312, USB commands are written to the host memory

At block 314 The values written to the registers and memory are detected and analyzed by the microcontroller firmware on the multifunction device. For commands, the microcontroller firmware reads the host memory descriptors. Some commands, such as polling commands, may be terminated at block 316. This may include placing a result in the host memory or modifying the USB registers accordingly. Other commands may be encapsulated and transmitted to the management console at block 318.

When the management console receives a USB command, it may generate a response from a USB mouse, USB keyboard, USB disk drive, or other USB device, encapsulate the response and send the encapsulated response to the host system. At block 320, the multifunction device receives and assembles the response from the management console and at block 322 it relays the response to the host memory, modifying the USB registers accordingly. At block 324, the universal host controller perceives the response from the virtual USB device at the USB hot-controller.

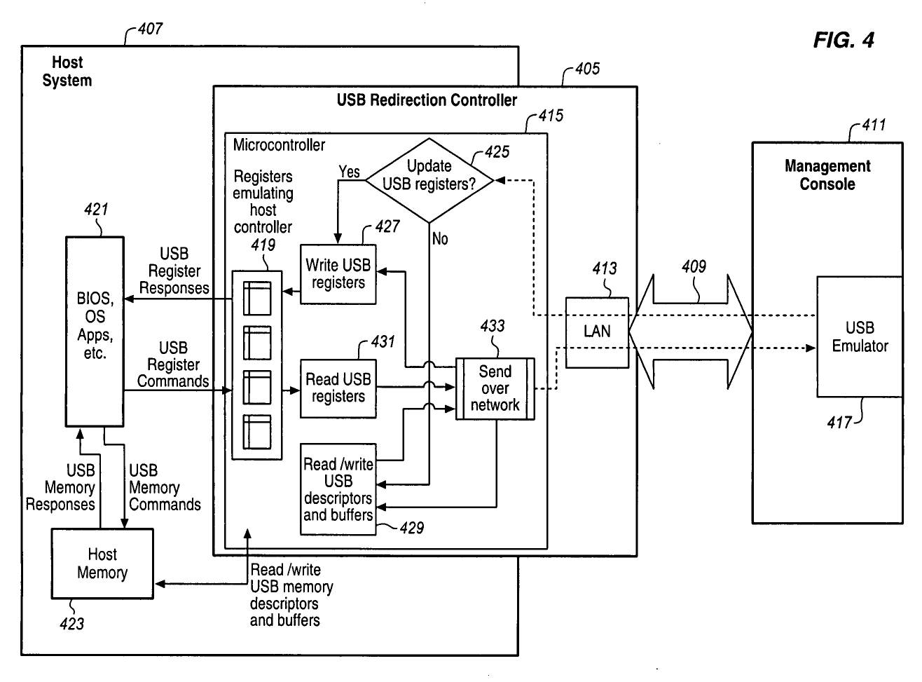

FIG. 4 shows a logical block diagram of a manageability-enabled platform 405 in a host system 407 coupled through a network 409 to a management console 411. This may be the same or a different system than that of FIGS. 1 and 2 and is provided to show different aspects of the invention which are not shown as clearly in FIGS. 1 and 2. Not all components of a complete system are shown in FIG. 4 in order to simplify the drawing figure. The system of FIG. 4 may be capable of performing the operations of FIG. 3 as well as many other operations.

The manageability-enabled platform may be embodied as the multifunction device 118 of FIG. 1, or it may be integrated into a system chipset or combined with other components. The significant aspects of the manageability-enabled platform shown here are USB redirection, so the platform 405 will be referred to as a USB redirection controller with reference to FIG. 4, although it may be applied for redirection of other peripheral device buses and not only USB. In one embodiment, the platform is part of a peripheral add-on card that includes USB redirection as described herein, LAN connectivity, IDE or mass storage redirection, input device redirection, video redirection and other management utilities.

The USB redirection controller includes a LAN controller 413 to interface with the network connection 409 and a microcontroller 415. The microcontroller may contain the USB registers 419, similar to those shown in FIG. 2 or a separate set of registers may be used. In the context of USB redirection, the microcontroller and the LAN communicate USB commands and data with each other so that USB commands and data may be sent over the LAN as described above in the context of FIG. 3. The USB commands and data may be communicated over the LAN as Ethernet packets with USB redirection commands and data. At the management console 411, these Ethernet packets are received and interpreted in a USB device emulator 417.

The USB device emulator may interpret the commands and data and generate its own USB commands and data to send to the USB redirection controller as Ethernet packets over the LAN. The commands and data may be responses or newly generated at the USB emulator. The USB emulator may have a connection to the user interface at the management console, so that an operator may use the USB emulator to emulate a mass storage device, a user input device, or any of a variety of other devices. It may also be used to emulate several devices. For example by emulating a keyboard, a mouse, and an external floppy disk drive, the USB emulator may be used to allow the management console to reboot the host system from a remote emulated floppy disk drive in order to upgrade host system firmware or BIOS.

In the host system 407, software functionality 421 communicates with system memory 423 and the microcontroller 419 in a variety of different ways. These are shown in a logical format in FIG. 4. In the example, of FIG. 4, from the perspective of the software functionality and the system memory, the USB redirection controller acts in substantially the same way as a PCI bus USB host controller. The software functionality 421 which may be a BIOS, an operating system or an application, depending on the state and configuration of the host system, sends USB register commands and receives USB register responses to the virtual USB host controller registers 419. Similarly, the software functionality sends USB memory commands to and receives responses from the system memory. These commands are picked up by the microcontroller 415 as if the microcontroller were a USB device and the microcontroller writes responses to the system memory as if it were a USB device.

Within the microcontroller, operations are performed in order to provide the USB device emulation to the host system. Ethernet packets received through the LAN controller are assembled into their USB constituents and analyzed at block 425 to determine whether they should be used to update any of the USB registers and, if so, which ones. If they are to be used to update the virtual USB host controller registers, then they are sent to a write block 427 coupled to the USB registers 419 to write the received data or values. These register updates will be picked up by the software functionality in the same way as with any real PCI USB device. If the data or values are not to be written to the virtual USB host controller registers, then they may be sent to a system memory write block 429 that sends the data or values to system memory.

In the opposite direction, data and values written into the USB host controller registers 419 by the software functionality 421 are detected by the read USB registers block 431. These are analyzed by a send over network decision block 433. If the data and values in the registers indicate commands or status requests that require a remote reply, then the commands or requests are forwarded to the LAN controller. The LAN controller encapsulates the data or values as mentioned above and forwards them on to the USB emulator of the management console. On the other hand, if the commands or requests may be answered locally, then a response is generated by the local microcontroller and the microcontroller generates a response for the USB register write logic 427 or the USB memory write logic 429.

Similarly, when data is written to the system memory for the virtual USB device, it is detected by the read/write USB memory logic 429 and sent to the send over network decision block 433. This block then either sends the newly written data to the LAN controller or a response is generated locally and sent either back to the read/write USB memory logic or to the USB register write logic 427.

As can be seen from FIG. 4, USB redirect to the management console may be provided without using a host USB port. In addition, a network connection, network connection controller, or firmware that is slower than a physical USB port may be used without sacrificing performance. This is in part true because the local USB controller responds directly to many of the overhead messages. Polling and other commands, for example, may be terminated locally.

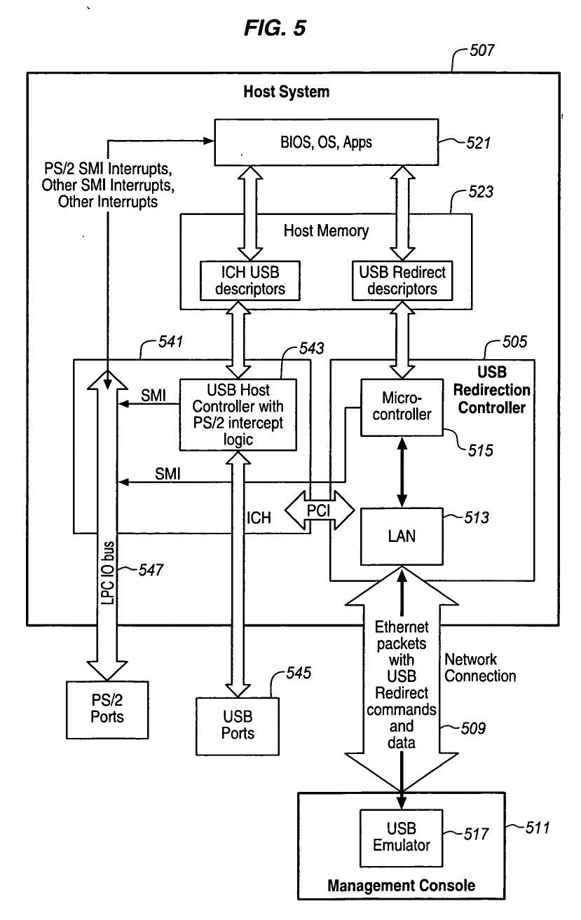

FIG. 5 shows a logical block diagram of an alternative or supplemented manageability-enabled platform or USB redirection controller 505 in a host system 507. Not all components of a complete system are shown in FIG. 5 in order to simplify the drawing figure. As in the example of FIG. 4, the USB redirection controller may be a system board device or it may be in the form of an adapter card. It is coupled through its own LAN controller 513 to a network 509 and to a management console 511. The management console includes a USB emulator 517. The host system and USB redirection controller may be the same or a different system than that of FIGS. 1, 2, and 4 and allow the manageability-enabled platform to support PS/2 (Personal System/2) I/O devices. The system of FIG. 5 may also be capable of performing the operations of FIG. 3 as well as many other operations.

As in the version of FIG. 4, the USB redirection controller 505 has a microcontroller 515 in communication with the LAN controller 513 and with the host system memory 523. The microcontroller may contain the USB registers shown in FIG. 2 or a separate set of registers may be used. In addition to the components of FIG. 4, FIG. 5 also shows an ICH (I/O Control Hub), which may or may not be included in the embodiment of FIG. 4. The ICH has a real USB host controller 543 coupled to external USB ports 545 and to the host system memory 523 to store USB descriptors. The ICH further includes a LPC (Low Pin Count) I/O bus 547 coupled to external PS/2 ports and to the software functionality 521. As a result, this hardware configuration supports both PS/2 and USB input and human interface devices through the ICH. PS/2 may be used to connect keyboards and pointing devices, such as a mouse, as well as floppy disk drives, parallel ports, serial ports, and infrared communication modems. While an ICH is shown for PS/2 and USB connections, the functions and components of the ICH may be integrated into another component of the host system.

The configuration of FIGS. 1, 2, and 4 allow the remote management console to communicate with the host system as though from a locally-connected USB keyboard and mouse. This allows a wide variety of diagnostics, installations, upgrades and repairs that would otherwise require direct local “hands-on” intervention from the user or an IT technician. Access through USB redirection may allow a local visit to be avoided.

However, some software systems, such as DOS (Disk Operating System) and other operating systems as well as some software applications do not support USB keyboards and mice. In some such systems, a PS/2 keyboard and mouse interface is required. The configuration of FIG. 5 allows USB redirection to be used even on systems that require PS/2 human interface devices by emulating PS/2 through the USB redirection controller 505. In one embodiment, the platform's BIOS emulates PS/2 by trapping writes to and reads from PS/2 addresses. A hardware interrupt, such as SMI (System Management Interrupt) may be generated by the USB redirection controller to notify the BIOS when the USB keyboard and mouse transactions are completed.

As with the embodiment of FIG. 4, the management console 511 connected to the USB redirection controller through the LAN controller recognizes USB commands transmitted from the host system's firmware. The management console interprets these commands and returns appropriate USB replies to the USB firmware through the USB redirection controller.

The USB redirection controller 505 includes a standard set of virtual USB registers including a PCI space as described above in the context of FIG. 2. The firmware or the microcontroller within the USB redirection controller receives and interprets controls and commands written to the virtual USB registers. It traverses the host system memory to which it is connected through, for example a MCH, and interprets the USB data structures and commands in the host system memory. As in the example of FIG. 4, the USB redirection controller may transmit and receive USB commands and data to the management console and write results received from the management console to the appropriate USB registers and buffers and descriptors of the host memory.

In addition to the capabilities and components described with respect to FIG. 4, the embodiment of FIG. 5 also includes manageability firmware that may generate SMI (System Management Interrupt) and transmit it through a connection to the LPC bus connection when it receives USB messages to the host system memory. The host system BIOS may be written so that it may receive the SMI and translate the received USB messages into PS/2 register values that can be read by an operating system or application. This allows the management console to emulate a USB device to the redirection controller and for the USB redirection controller and BIOS to emulate a PS/2 device that can be understood by the software functionality 521. This allows the host system to use emulated USB I/O devices with software that does not support such devices.

The host system BIOS 521 may be written to emulate PS/2 keyboard and mouse and other devices over both of the USB host controllers shown in FIG. 5, the USB host controller of the ICH 541 and the virtual USB host controller of the USB redirection controller 505.

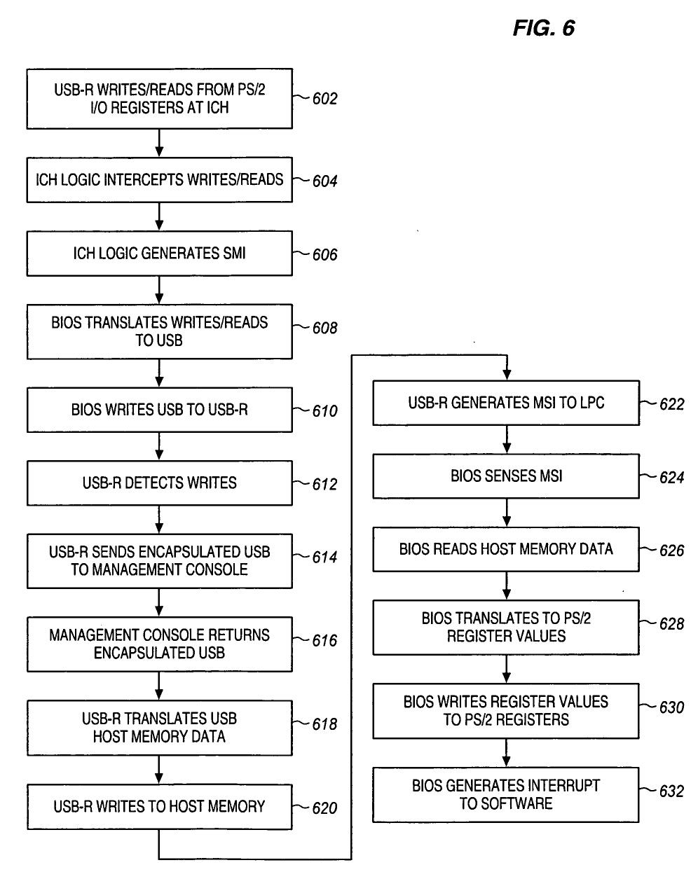

In operation, and as shown in FIG. 6, when the USB redirection controller writes to and reads from the PS/2 I/O registers at the ICH at block 602, the ICH USB host controller logic intercepts the write and read operations performed at the PS/2 ports at block 604 and generates an interrupt at block 606, such as SMI, to the BIOS. The BIOS translates the writes and reads to USB commands at block 608 and writes them to the USB host controller as well as to the USB redirection controller at block 610. The USB redirection controller firmware detects the I/O activity on its own registers at block 612 and generates appropriate encapsulated USB commands and data to the management console through the LAN controller at block 614.

At block 616, the management console receives the commands and data at its USB emulator and sends responses together with its own USB commands and data back to the USB redirection controller. The USB redirection controller translates the USB commands and data into host memory data at block 618 which it writes to the USB data area of the host system memory at block 620. The USB redirection controller also generates an interrupt, such as MSI (Message Signaled Interrupt to the host system's LPC bus at block 622.

When the host system's BIOS senses the LPC interrupts at block 624, it reads the USB host memory data at block 626 and translates it to PS/2 response register values at block 628. The BIOS then writes the translated PS/2 response register values to the PS/2 registers at block 630, as if the values came from a local PS/2 device, such as a keyboard, mouse, or floppy disk drive. The host system BIOS may then generate an interrupt at block 632 to the software functionality that will operate as if the interrupt came from a local PS/2 device.

Using the ICH PS/2 intercept logic avoids any requirement to implement PS/2 intercept logic in the USB redirection controller. ICH PS/2 intercept logic generates the SMI to the BIOS and the BIOS detects the PS/2 reads and writes. The BIOS then translates the reads and writes into USB messages to the real USB controller and the virtual USB controller. Conversely, when USB data is written to the host memory by either the real USB controller or the virtual USB controller, the BIOS is interrupted by MSI The BIOS can then detect the source of the USB data by reading each host controller's status register. To support sending interrupts to the BIOS, the USB redirection controller may have a connection to the LPC bus, for example through the ICH as shown in FIG. 5. This connection may embed Serial IRQ (Interrupt Request) logic that supports SMI, or another appropriate interrupt. Alternatively, with PS/2 intercept logic in the redirection controller, the USB redirection controller may be coupled directly to the local PS/2 bus to send interrupts and data.

Embodiments of the invention may be implemented in one or a combination of hardware, firmware, and software. Embodiments of the invention may also be implemented as instructions stored on a machine-readable medium, which may be read and executed by at least one processor to perform the operations described herein. A machine-readable medium may include any mechanism for storing or transmitting information in a form readable by a machine (e.g., a computer). For example, a machine-readable medium may include read-only memory (ROM), random-access memory (RAM), magnetic disc storage media, optical storage media, flash-memory devices, electrical, optical, acoustical or other form of propagated signals (e.g., carrier waves, infrared signals, digital signals, etc.), and others.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims.

In the foregoing detailed description, various features are occasionally grouped together in a single embodiment for the purpose of streamlining the disclosure. This method of disclosure is not to be interpreted as reflecting an intention that the claimed embodiments of the subject matter require more features than are expressly recited in each claim. Rather, as the following claims reflect, inventive subject matter lies in less than all features of a single disclosed embodiment. Thus, the following claims are hereby incorporated into the detailed description, with each claim standing on its own as a separate preferred embodiment.

What is claimed is:

1. An apparatus comprising:
a bus adapter to connect to a bus of a managed system;
a set of peripheral device bus host controller registers to provide data and commands to the bus adapter;
a network adapter to communicate data and commands between the set of host controller registers and a remote networked device.

2. The apparatus of claim 1, wherein the peripheral device bus is a Universal Serial Bus (USB).

3. The apparatus of claim 1, wherein the managed system bus is a Peripheral Component Interconnect (PCI) bus.

4. The apparatus of claim 1, further comprising a microcontroller coupled to the network adapter, the microcontroller including the bus adapter and the set of host controller registers, the microcontroller intercepting commands on the host controller registers and generating responses thereto.

5. The apparatus of claim 4, wherein the microcontroller alternately terminates commands on the host controller registers by placing a response in a host controller register or transmits commands to the network adapter.

6. The apparatus of claim 4, wherein the microcontroller terminates polling traffic on the set of host controller registers without transmitting it to the network adapter.

7. The apparatus of claim 1, further comprising generating an interrupt to a user interface I/O device bus.

8. The apparatus of claim 1, wherein the interrupt comprises a System Management interrupt to a Low Pin Count bus.

9. The apparatus of claim 1, further comprising transmitting the commands to I/O registers of an I/O controller hub.

10. The apparatus of claim 1, wherein the commands comprise keyboard and mouse commands, the method further comprising sending the keyboard and mouse commands to an I/O controller hub.

11. The apparatus of claim 1, further comprising translating commands of the bus host controller to commands of a local I/O device and writing the commands to a local I/O device register.

12. A computer system comprising:
a host controller;
a peripheral device bus coupled to the host controller;
a redirection controller coupled to the peripheral device bus, the redirection controller comprising a set of peripheral device bus host controller registers to provide data and commands to the peripheral device bus, and a network controller to communicate data and commands between the set of host controller registers and a remote networked device.

13. The apparatus of claim 12, wherein the network controller intercepts commands on the host controller registers and generates responses thereto.

14. The apparatus of claim 13, wherein the network controller alternately terminates commands on the host controller registers by placing a response in a host controller register or transmits commands to the remote networked device.

15. A method comprising:
providing data and commands to a bus adapter coupled to a bus of a host system;
communicating data and commands between a set of peripheral device host controller registers and a remote networked device, and
alternately terminating commands on the host controller registers by placing a response in a host controller register or transmitting commands to the remote networked device.

16. The method of claim 15, further comprising intercepting commands on the host controller registers and generating responses thereto.

17. The method of claim 15, further comprising terminating polling traffic on the set of host controller registers without transmitting it to the remote networked device.

18. The method of claim 15, further comprising generating an interrupt to a user interface I/O device bus.

19. The method of claim 15, further comprising transmitting the commands to I/O registers of an I/O controller hub.

20. The method of claim 15, further comprising translating commands of the bus host controller to commands of a local I/O device and writing the commands to a local I/O device register.
